(19) United States
(12) Patent Application Publication
(10) Pub. No.: US 2006/0159151 A1
(43) Pub. Date: Jul. 20, 2006

(54) Device for switching a laser beam, laser machining device

(76) Inventor: Hans Jurgen Mayer, Viernheim (DE)

Correspondence Address: HARNESS, DICKEY & PIERCE, P.L.C., P.O. BOX 8910, RESTON, VA, 20195, US

(21) Appl. No.: 11/312,577

(22) Filed: Dec. 21, 2005

(30) Foreign Application Priority Data
Dec. 23, 2004 (DE) 10 2004 062 381.3

(51) Int. Cl. H01S 3/08; B23K 26/00

(52) U.S. Cl. 372/98; 372/106; 219/121.6

(57) ABSTRACT

A switch-over device is disclosed for selectively switching a linearly polarized input laser beam to a first output laser beam or to a second output laser beam. The switch-over device includes a primary optical switch-over element having a primary optical element for selectively rotating the polarization direction of the input laser beam and a downstream primary polarization-dependent reflector which guides the input laser beam depending on its polarization direction to a first course of ray or to a second course of ray. In each of the two courses of ray, a further optical switch-over element is respectively provided which includes a secondary optical element for selectively rotating the polarization direction of the respective laser beam and a secondary polarization-dependent reflector which guides the respective laser beam depending on its polarization direction to an output laser beam. Furthermore, a laser machining device is disclosed, including a laser beam switch-over device as mentioned above.

The present application hereby claims priority under 35 U.S.C. §119 on German patent application number DE 10 2004 062 381.3 filed Dec. 23, 2004, the entire contents of which is hereby incorporated herein by reference.

### FIELD

The description generally relates to a device for selectively switching an input laser beam polarized, for example one in a substantially linear manner, to a first output laser beam or to a second output laser beam. Furthermore, the invention generally relates to a laser machining device, for example one for the fast machining of workpieces. In particular, it may relate to one for the drilling and/or structuring of electronic circuit carriers, wherein the laser machining device may include a laser beam switching device as mentioned above, for example.

### BACKGROUND

Nowadays, electronic assemblies which are to be realized in a compact configuration are often constructed on multilayer circuit carriers, particularly on multilayer circuit boards. In doing so it is necessary to bring specific conductive layers of the circuit board into contact. This is achieved by drilling a blind hole or through hole into the layers to be brought into contact and by subsequently coating the hole with an electrically conductive metallization. In this way circuit paths may be formed not only two-dimensionally but also in the third dimension such that the space required by electronic assemblies can be reduced considerably.

Usually, circuit boards are drilled by way of pulsed laser radiation in special laser machining devices for the field of electronics. Normally, CO₂ or solid-state lasers, such as Nd:YAG or Nd:YVO₄ lasers, are used as laser sources. Important features for a competitive laser machining device are the throughput, i.e. the number of holes which can be drilled within a specific time unit, on the one hand and the costs of purchase for the laser machining device on the other.

Therefore, laser machining devices have been developed wherein the laser beam emitted by a single laser source can be optionally deflected to one of two partial courses of ray by means of a fast switching element. In each partial course of ray there are provided a deflection unit and an imaging unit with which the respective partial beam is guided to different target points on one or more of the workpieces to be machined.

During such beam switch-over an increase of the throughput is achieved by using the time span required for drilling a hole with a first laser beam to position deflection mirrors of a deflection unit for the second laser beam. Thus, directly after the drilling operation with the first laser beam has finished, the laser machining by the second laser beam may begin by correspondingly switching over to the second laser beam. In this way, useless secondary processing times are eliminated wherein deflection units are positioned to different target points of the laser beam which are may be spaced far apart. A corresponding device for alternately drilling a circuit board with a laser beam and positioning a deflection unit for the other laser beam is known, for example, from JP 2002-011584 A.

From JP 2003-126982 A there is known a laser machining device is which as a beam switch-over element includes an electro-optical modulator cooperating with a polarization-dependent reflector. By appropriately controlling the electro-optical modulator the polarization direction of the laser beam impinging on the polarization-dependent reflector may be selectively influenced so that the laser beam may optionally be guided to one of two output beam courses downstream of the polarization-dependent reflector. However, as the laser radiation impinging on the electro-optical modulator is never perfectly polarized, and moreover the angle of rotation of the polarization direction generated by an electro-optical modulator always shows a certain amount of indistinctness, some residual intensity always enters the course of ray of the switched-off laser beam.

In order to avoid undesired damage to the workpiece by this residual beam intensity, additional polarizers are provided in the laser machining device which reduce the leak rate of undesired laser radiation onto the workpiece to be machined to a minimum. This laser machining device is disadvantageous in that the intensity of the two laser beams machining the workpiece cannot be controlled independently for each laser beam.

### SUMMARY

It is an object of at least one embodiment of the invention to provide a device for selectively switching an input laser beam into a first output laser beam or into a second laser beam which on the one hand enables a fast switching time and an individual adjustment of the laser power respectively directed to a workpiece on the other. Furthermore, it is an object of at least one embodiment of the invention to provide a laser machining device wherein a laser beam switch-over device as described above may be efficiently used for quickly and precisely machining workpieces.

The device according to at least one embodiment of the invention includes a primary optical element for the selective rotation of the polarization direction of the input laser beam and a polarization-dependent reflector downstream of the primary optical element. The reflector is designed such that a portion of the impinging laser light polarized in a first direction may be guided to a first course of ray and a portion polarized in the second direction may be guided to a second course of ray.

In the first course of ray a first secondary optical element for the selective rotation of the polarization direction of the laser light guided to the first course of ray as well as a first secondary polarization-dependent reflector downstream of the first secondary optical element are located for spatially separating two first beam portions polarized in two different directions, with one of the first two beam portions representing the first output laser beam. In the second course of ray a second secondary optical element for the selective rotation of the polarization direction of the laser light guided to the second course of ray and a second secondary polarization-dependent reflector downstream of the second secondary optical element are likewise provided. It serves to spatially separate two different polarized second beam portions, with one of the two second beam portions representing the second output laser beam.

At least one embodiment of the invention is based on the perception that a primary optical deflection element which includes the primary optical element and the primary polarization-dependent reflector guides the intensity of an incident laser beam by specifically controlling the primary optical element optionally to one of two courses of ray. The secondary switch-over elements which each include a secondary optical element and a downstream secondary polarization-dependent reflector fulfil two purposes in an advantageous way.

A first purpose of at least one embodiment resides in that an undesired leak intensity which penetrates into the respective course of ray and has been caused, for example, by a non-perfect linear polarization of the input laser beam or a non-perfect switching of the polarization direction of the input laser beam is faded out from the respective course of ray. Thus, no undesired laser intensity or at least only a very strongly suppressed undesired laser intensity penetrates through the respective non-activated course of ray onto a workpiece to be machined.

A second purpose of at least one embodiment resides in that by correspondingly controlling the secondary optical element which is located in the activated course of ray, the light intensity impinging at high speed on the workpiece to be machined may be adjusted to the respective machining operation. Thus, no additional elements such as controllable optical reducers are required to adjust the power and the power may be adjusted on a short time scale.

In at least one example embodiment, the polarization-dependent reflectors may be designed and suitably arranged such that two mutually perpendicular polarization directions are separated from each other. Usually, the one polarization is oriented in parallel and the other polarization perpendicular to a plane wherein all courses of ray of the laser beam deflection device of at least one embodiment of the invention are located.

It should be noted that the inventive device of at least one embodiment may also be used for selectively switching an input laser beam into more than two output laser beams if further switch-over elements each having an optical element and a downstream polarization-dependent reflector are connected in series in an appropriate manner. In this case, several inventive devices may act together in the form of a cascade such that the input laser beam may be selectively guided to one of three, four or even more of several output laser beams.

In case of an array configured as a cascade from more than two optical switching elements connected in series having each an optical element and a polarization-dependent reflector, the leak rate, i.e., the laser intensity, which passes through a course of ray that is actually not activated can be further reduced.

According to at least one embodiment, beam portions may be guided to a first and into a second beam trap, respectively, by the first secondary polarization-dependent reflector and the second secondary polarization-dependent reflector, respectively. This is advantageous in that the faded-out beam portions do not generate any undesired scattered radiation which, for example, might affect an optical position measurement of workpieces to be machined.

According to at least one embodiment, at least one of the optical elements is an electro-optical or a magneto-optical modulator. The term electro-optical modulator refers to any kind of modulator which influences the polarization direction of a light beam by the electro-optical effect, in particular by the Kerr effect or by the Pockels effect. The term magneto-optical modulator refers to a modulator which influences the polarization direction of a light beam by the magneto-optical effect, in particular by the Faraday effect. Electro-optical and magneto-optical modulators are advantageous in that they enable an extremely fast switch-over of the polarization direction such that even in the case of a pulsed input laser beam having a repetition frequency in the range of up to 100 kHz a switch-over between two consecutive laser pulses is possible. Thus, even in case of a high repetition frequency each laser pulse may be used for machining material. In addition to that, the power and energy, respectively, may be controlled based on the pulses.

According to at least one embodiment, at least one of the polarization-dependent reflectors is a transparent optical element having a surface oriented relative to the respective light beam at a Brewster angle. In the simplest case the polarization-dependent reflectors respectively are simple coplanar glass plates, with the Brewster angle being determined by the refractive index n of the glass material. The simple glass panes are advantageous in that they are very reasonably priced optical elements and moreover are able to stand high laser power without any clouding or other damage. However, other polarization-dependent reflectors, such as birefringent crystals, may of course be used as well.

Another object of at least one embodiment of the invention may be achieved by a laser machining device for the fast machining of workpieces, in particular for the drilling and/or structuring of electronic circuit carriers. The laser machining device according to at least one embodiment of the invention includes a laser beam switch-over device, a laser oscillator set up for transmitting the input laser beam polarized in a substantially linear manner, a first deflection unit arranged in the first output laser beam and a second deflection unit arranged in the second laser beam. The two deflection units are respectively provided for the positioning of one of the two output laser beams on provided target points on at least one workpiece.

The laser machining device according to at least one embodiment of the invention enables the alternate machining of material on two machining areas. During the machining by the first output laser beam the second deflection unit is positioned to a target point which immediately after the machining by the first output laser beam has finished is reached by the second output laser beam through a switch-over by the laser beam switch-over device. Especially if fast optical elements are used to selectively rotate the polarization direction of the laser beam, it is thus possible to achieve a beam switch-over between two consecutive pulses of a pulsed laser oscillator. In this manner secondary processing times during material machining caused by a jump movement of a deflection unit between various target positions are completely eliminated as far as these time spans are used to machine material with a laser beam guided by the respective other deflection unit.

The deflection units in general are so-called Galvo mirrors wherein two Galvo mirrors supported rotatably around axes perpendicular to each other are moved such that a laser beam guided across the two Galvo mirrors may be directed to any target points within a machining area.

The laser machining device according to at least one embodiment additionally may include a control unit which is coupled to the primary optical element, the first secondary optical element and the second secondary optical element. This enables an individual control of all optical elements, with the control unit additionally being possibly provided for controlling the laser oscillator and/or the two deflection units.

According to at least one embodiment, the control unit may be designed such that the laser machining device can be switched into a first operating condition. In doing so, the input laser beam is substantially transferred to a first course of ray and a first residual remainder of the intensity of the input laser beam transferred to the second course of ray is influenced by the second secondary optical element as regards its polarization so that this first remainder is removed from the course of ray of the second output laser beam by the second secondary polarization-dependent reflector. Moreover, the polarization of the laser beam transferred to the first course of ray can be adjusted by a proper control of the first secondary optical element such that the first output laser beam impinges on the workpiece to be machined at a predetermined radiation power.

Thus, it is possible to keep an undesired residual intensity transferred to the second course of ray from the workpiece and also to adjust the intensity of the first output laser beam impinging on the workpiece to be machined in an optimal manner to the respective material machining. Thus, individual pulses as well as pulse sequences (so-called bursts) of greater or shorter length may be generated, resulting in a variety of new application purposes.

According to at least one embodiment, a second operating condition can be adjusted in an analogous manner wherein the intensity of the second output laser beam can be adjusted optimally and a residual intensity is almost completely removed from the first course of ray.

### BRIEF DESCRIPTION OF THE DRAWINGS

Further advantages and features of the present invention can be taken from the following example description of example embodiments.

In the drawings,

FIG. 1 shows a laser machining device in a first operating condition, and

FIG. 2 shows the laser machining device of FIG. 1 in a second operating condition in schematic illustrations.

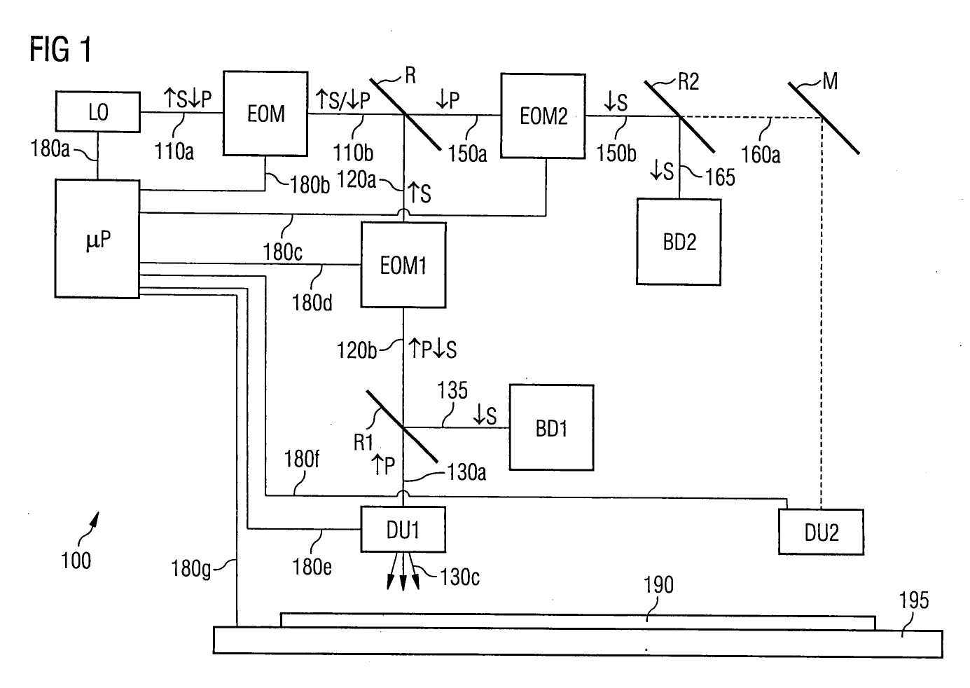

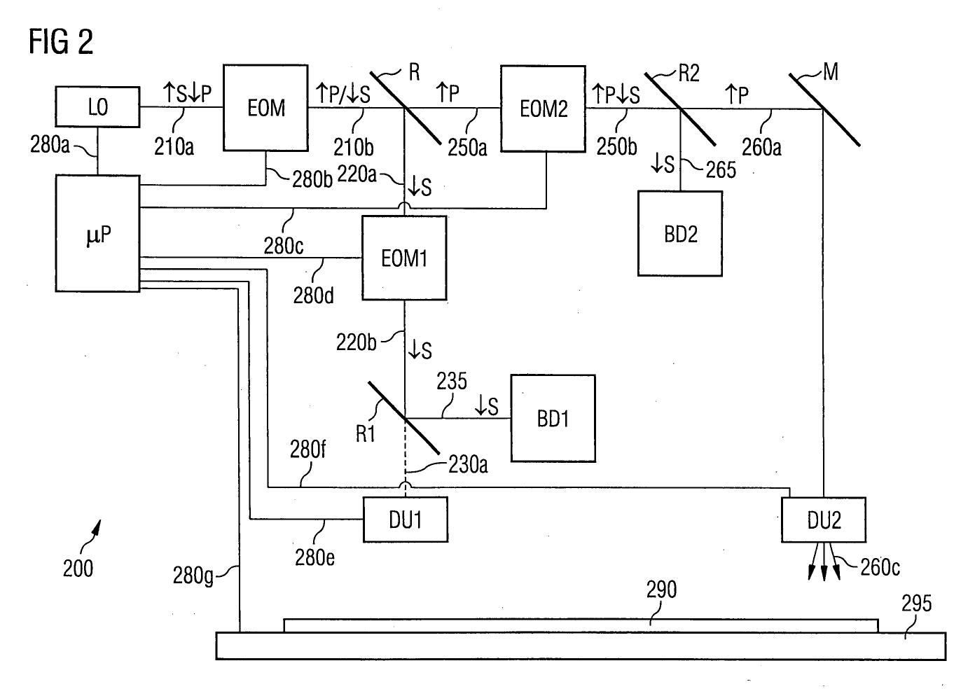

At this point it is to be noted that in FIGS. 1 and 2 identical components are denoted by the same reference numerals or by equivalent reference numerals which merely differ in their first digits.

### DETAILED DESCRIPTION OF THE EXAMPLE EMBODIMENTS

In the first operating condition of a laser machining device 100 shown in FIG. 1, a laser oscillator LO emits an input laser beam 110a polarized in a substantially linear manner. If the laser oscillator LO includes a laser beam having a low degree of polarization an additional polarizer would have to be used which imparts the required linear polarization to the input laser beam 110a.

The polarization direction of the input laser beam 110a is substantially perpendicular to the plane of projection and therefore includes a large portion of the so-called S polarization and merely a small portion of the so-called P polarization. This is illustrated in the drawing in that the letter S is preceded by an upward pointing arrow and the letter P is preceded by a downward pointing arrow. In the following the systematics of this schematic identification will be adhered to. The letters “S” and “P”, respectively, indicate the respective polarization direction. A preceding upward pointing arrow denotes a large portion and a preceding downward pointing arrow denotes a small portion of the respective polarization direction.

The input laser beam 110a impinges on a primary electro-optical modulator EOM which, when properly controlled, which will be explained later, can rotate the polarization direction of the laser beam 110b leaving the modulator EOM by any angle. In the first operating condition the primary electro-optical modulator EOM is controlled such that the polarization direction of the laser beam 110b as compared to the polarization direction of the input laser beam 110a will not be changed. Thus, the input laser beam 110b still includes a large portion of S polarization and merely a small portion of P polarization.

A primary Brewster window R is connected downstream of the primary optical modulator EOM. It is preferred that the Brewster window be a coplanar glass plate which is arranged at the Brewster angle relative to the course of ray of the laser beam 110b. Thus, the large portion of S polarization is reflected in a first course of ray 120a. The small portion of P polarization penetrates the primary Brewster window R at a parallel offset depending on the thickness of the glass plate and is guided to a second course of ray 150a.

The S polarization portion reflected in the first course of ray 120a impinges on a first secondary electro-optical modulator EOM1 which, when controlled properly, is also capable of rotating the polarization direction of the corresponding laser beam. As can be taken from FIG. 1, the modulator EOM1 in the first operating condition is controlled such that the laser beam 120b leaving the modulator EOM1 now substantially includes a P polarization. Thus, a substantially P polarized portion impinges on a first secondary Brewster window R1.

The first secondary Brewster window R1 is established such that the P polarized portion of the impinging laser beam is transmitted as a first output laser beam 130a and an S polarized portion is reflected and guided to a first beam trap BD1 as the laser beam 135. The first output laser beam 130a is directed to specific target points of a workpiece 190, which is located on a positioning table 195, by way of a first deflection unit DU1 within a machining area. The laser beams exiting from the first deflection unit DU1 are schematically shown in FIG. 1 as first machining laser beams 130c.

By selectively controlling the first secondary electro-optical modulator EOM1 the polarization direction of the laser beam 120b leaving the modulator EOM1 is thus rotated, and as a result the intensity of the first output laser beam 130a is selectively reduced to intensity and power values, respectively, which depend on the respective material machining. The difference intensity is guided to the beam trap BD1 as the laser beam 135. This makes it possible to quickly adjust the intensity of the first machining laser beams 130c to the respectively required material machining.

The P portion transmitted by the primary Brewster window R impinges on a second secondary electro-optical modulator EOM2 arranged in the second course of ray 150a. In the first operation condition shown in FIG. 1 the modulator EOM2 rotates the polarization of the laser beam 150b leaving the modulator EOM2 toward an S polarization. Thus, as a result a substantially S polarized laser beam having a weak intensity impinges on a second secondary Brewster window R2. This causes the S polarized beam 150b to be reflected as the laser beam 165 and to be guided to a second beam trap BD2. In this way it will be ensured that the residual laser intensity guided to the second course of ray 150a does not accidentally impinge on a second deflection unit DU2 via a deflection mirror M as a second output laser beam 160a. Thus, in the first operating condition accidental material damage caused by a laser beam guided via the second deflection unit DU2 is not possible.

The intensity and power, respectively, of the laser radiation guided to the workpiece via the second deflection unit DU2 can be estimated as follows: The polarization quality of commercially available lasers is typically in the range of 100:1. Corresponding figures are valid for a switch-over element consisting of an electro-optical modulator and a Brewster window, which also indicates a switching quality of about 100:1 up to a maximum of 1000:1.

As a result, the “activated” laser beam as compared to a non-“activated” laser beam is stronger by a factor of 105 to 106 maximum as regards its intensity and power, respectively. Thus the intensity and power, respectively, of the “switched-off” beam is only 0.01% to 0.001% of the intensity of the input laser beam. In the case of such strong suppression no undesired machining effects can be caused to the workpiece 190 by the second output laser beam 160a.

According to the present example embodiment, the complete course of the laser machining is controlled by a central control unit μp which is connected to the laser oscillator LO, the primary electro-optical modulator EOM, the first and the second secondary electro-optical modulator EOM1 and EOM2, the two deflection units DU1 and DU2 as well as the positioning table 195 via control lines 180a, 180b, 180c, 180d, 180e, 180f, and 180g.

In the second operating condition of the laser machining device 200 shown in FIG. 2 the polarization direction of the input laser beam 211a is rotated by 90° by the primary electro-optical modulator EOM. Consequently, the laser beam 210b leaving the modulator EOM includes a large portion of the P polarization and a small portion of the S polarization. Now a strong P polarization portion as compared to the first operating condition is guided to the second course of ray 250a wherein the polarization direction of the laser beam 250b leaving the modulator EOM2 can be adjusted in a suitable manner by appropriately controlling the second secondary electro-optical modulator EOM2. Thus, the second output laser beam 260a may be optimally adjusted for material machining as regards its intensity. Consequently, depending on the polarization direction of the laser beam 250b respectively adjusted a laser beam 265 polarized in the S direction will be guided to the beam trap BD2 at a more or less strong intensity.

A considerable reduction of the intensity of the laser beam guided to the first course of ray 220a is achieved by the cooperation of the modulator EOM1 and the Brewster window R1. That is, in the second operating condition the polarization direction of the laser light guided to the first course of ray 220a is not rotated such that the largest part of the laser light 220b, which is already weak anyway, will be reflected on the Brewster window R1 and guided to the first beam trap BD1 as the laser beam 235. Corresponding to the quantitative estimation of the intensity mentioned above, the intensity of the laser light transmitted via the deflection unit DU1 in the second operating condition will thus be weakened to a factor of 10⁻⁴ so that accidental material machining of the workpiece 295 will not have to be worried about. At the same time, by appropriately controlling the second secondary electro-optical modulator EOM2, the light intensity of the second machining laser beams 260c can be freely adjusted, i.e. individually for each laser pulse.

In summary, the following can be observed:

At least one example embodiment of the invention provides a switch-over device for selectively switching a linearly polarized input laser beam (110a) to a first output laser beam (130a) or to a second output laser beam (160a). The switch-over device includes a primary optical switch-over element having a primary optical element (EOM) for selectively rotating the polarization direction of the input laser beam (110a) and a downstream primary polarization-dependent reflector (R) which guides the input laser beam depending on its polarization direction to a first course of ray (120a) or to a second course of ray (150a).

In each of the two courses of ray (120a and 150a, respectively), a further optical switch-over element is respectively provided which includes a secondary optical element (EOM1 and EOM2, respectively) for selectively rotating the polarization direction of the respective laser beam (120b and 150b, respectively) and a secondary polarization-dependent reflector (R1 and R2, respectively) which guides the respective laser beam depending on its polarization direction to an output laser beam (130a and 160a, respectively). Furthermore, the invention provides a laser machining device including a laser beam switch-over device as mentioned above.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE NUMERALS

100 laser machining device (1st operating condition)
LO laser oscillator
110a input laser beam
S polarization direction
P polarization direction
↑ high intensity/power
↓ low intensity/power
EOM primary electro-optical modulator
110b laser beam (after EOM)
R primary Brewster window
120a first course of ray
EOM1 first secondary electro-optical modulator
120b laser beam (after EOM1)
R1 first secondary Brewster window
130a first output laser beam
DU1 first deflection unit
130c first machining laser beam
135 laser beam (for beam trap)
BD1 first beam trap
150a second course of ray
EOM2 second secondary electro-optical modulator
150b laser beam (after EOM1)
R2 second secondary Brewster window
160a second output laser beam
M deflection mirror
165 laser beam (for beam trap)
BD2 second beam trap
DU2 second deflection unit
μP control unit
180a/b/c/d/e/f/g control line
190 workpiece
195 positioning table
200 laser machining device (2nd operating condition)
LO laser oscillator
210a input laser beam
S polarization direction
P polarization direction
↑ high intensity/power
↓ low intensity/power
EOM primary electro-optical modulator
210b laser beam (after EOM)
R primary Brewster window
220a first course of ray
EOM1 first secondary electro-optical modulator
220b laser beam (after EOM1)
R1 first secondary Brewster window
230a first output laser beam
235 laser beam (for beam trap)
BD1 first beam trap
DU1 first deflection unit
250c second course of ray
EOM2 second secondary electro-optical modulator
250b laser beam (after EOM1)
R2 second secondary Brewster window
260a second output laser beam
M deflection mirror
DU2 second deflection unit
260c second machining laser beam
265 laser beam (for beam trap)
BD2 second beam trap
μP control unit
280a/b/c/d/e/f/g control line
290 workpiece
295 positioning table

What is claimed is:

1. A device for selectively switching an input laser beam polarized in a substantially linear manner to at least one of a first output laser beam and to a second output laser beam, comprising:
a primary optical element for selectively rotating the polarization direction of the input laser beam;
a primary polarization-dependent reflector downstream of the primary optical element, designed such that
a portion of the impinging laser polarized in a first direction is guidable to a first course of ray, and
a portion of the impinging laser light polarized in a second direction direction is guidable to a second course of ray;
a first secondary optical element arranged in the first course of ray for selectively rotating the polarization direction of the laser light guided to the first course of ray;
a first secondary polarization-dependent reflector downstream of the first secondary optical element for spatially separating two first beam portions polarized in two different directions, with one of the first two beam portions representing the first output laser beam;
a second secondary optical element arranged in the second course of ray for selectively rotating the polarization direction of the laser light guided to the second course of ray; and
a second secondary polarization-dependent reflector downstream of the second secondary optical element for spatially separating two secondary beam portions polarized in two different directions, with one of the two second beam portions representing the second output laser beam.

2. The device according to claim 1, additionally comprising:
a first beam trap, positioned relative to the first secondary polarization-dependent reflector such that the other of the two first beam portions is deliverable to the first beam trap.

3. The device according to claim 1, additionally comprising:
a second beam trap, positioned relative to the second secondary polarization-dependent reflector such that the other of the two second beam portions is deliverable to the second beam trap.

4. The device according to claim 1, wherein at least one of
the primary optical element,
the first secondary optical element, and
the second secondary optical element
is at least one of an electro-optical modulator and a magneto-optical modulator.

5. The device according to claim 1, wherein at least one of
the primary polarization-dependent reflector,
the first secondary polarization-dependent reflector, and
the second secondary polarization-dependent reflector
is a transparent optical element and includes a surface oriented relative to the respective incident light beam at a Brewster angle.

6. A laser machining device for the rapid machining of workpieces, comprising:
a device according to claim 1;
a laser oscillator set up for transmitting the input laser beam polarized in a substantially linear manner;
a first deflection unit arranged in the first output laser beam; and
a second deflection unit arranged in the second output laser beam, wherein the first and second deflection units are provided on predetermined target points on at least one workpiece for positioning the two output laser beams.

7. The laser machining device according to claim 6, additionally comprising:
a control unit being coupled to the primary optical element, the first secondary optical element, and the second secondary optical element.

8. The laser machining device according to claim 7, wherein the control unit is designed such that in a first operating condition,
the input laser beam is substantially transferred to the first course of ray,
a residual first remainder of the intensity of the input laser beam transferred to the second course of ray is influenced by the second secondary optical element with regard to its polarity so that this first remainder is removed by the second secondary polarization-dependent reflector from the course of ray of the second output laser beam, and
the polarization of the laser beam transferred to the first course of ray is adjusted by the first secondary optical element such that the first output laser beam impinges on the workpiece to be machined with a predetermined radiation power.

9. The laser machining device according to claim 8, wherein the control unit is designed such that in a second operating condition,
the input laser beam is substantially transferred to the second course of ray,
a residual second remainder of the intensity of the input laser beam transferred to the first course of ray is influenced by the fist secondary optical element with regard to its polarity so that this second remainder is removed by the first secondary polarization-dependent reflector from the course of ray of the first output laser beam, and
the polarization of the laser beam transferred to the second course of ray is adjusted by the second secondary optical element such that the second output laser beam impinges on the workpiece to be machined with a predetermined radiation power.

10. The device according to claim 2, additionally comprising:
a second beam trap, positioned relative to the second secondary polarization-dependent reflector such that the other of the two second beam portions is deliverable to the second beam trap.

11. The device according to claim 2, wherein at least one of
the primary optical element,
the first secondary optical element, and
the second secondary optical element
is at least one of an electro-optical modulator and a magneto-optical modulator.

12. The device according to claim 3, wherein at least one of
the primary optical element,
the first secondary optical element, and
the second secondary optical element
is at least one of an electro-optical modulator and a magneto-optical modulator.

13. The device according to claim 10, wherein at least one of
the primary optical element,
the first secondary optical element, and
the second secondary optical element
is at least one of an electro-optical modulator and a magneto-optical modulator.

14. The laser machining device of claim 6, wherein the laser machining device is for at least one of drilling and structuring electronic substrate carriers.

15. A laser machining device for the rapid machining of workpieces, comprising:
a device according to claim 2;
a laser oscillator set up for transmitting the input laser beam polarized in a substantially linear manner;
a first deflection unit arranged in the first output laser beam; and
a second deflection unit arranged in the second output laser beam, wherein the first and second deflection units are provided on predetermined target points on at least one workpiece for positioning the two output laser beams.

16. A laser machining device for the rapid machining of workpieces, comprising:
a device according to claim 10;
a laser oscillator set up for transmitting the input laser beam polarized in a substantially linear manner;
a first deflection unit arranged in the first output laser beam; and
a second deflection unit arranged in the second output laser beam, wherein the first and second deflection units are provided on predetermined target points on at least one workpiece for positioning the two output laser beams.

17. The laser machining device according to claim 15, additionally comprising:
a control unit being coupled to the primary optical element, the first secondary optical element, and the second secondary optical element.

18. The laser machining device according to claim 16, additionally comprising:
a control unit being coupled to the primary optical element, the first secondary optical element, and the second secondary optical element.

19. The laser machining device according to claim 7, wherein the control unit is designed such that in a second operating condition,
the input laser beam is substantially transferred to the second course of ray,
a residual second remainder of the intensity of the input laser beam transferred to the first course of ray is influenced by the fist secondary optical element with regard to its polarity so that this second remainder is removed by the first secondary polarization-dependent reflector from the course of ray of the first output laser beam, and
the polarization of the laser beam transferred to the second course of ray is adjusted by the second secondary optical element such that the second output laser beam impinges on the workpiece to be machined with a predetermined radiation power.
